(19) United States
(12) Patent Application Publication
(10) Pub. No.: US 2014/0315175 A1
(43) Pub. Date: Oct. 23, 2014

(54) SYSTEM FOR SIMULATING LUNG FUNCTION

(71) Applicants: Hoang Nguyen, San Jose, CA (US); Ryan Olivera, Granite Bay, CA (US); Alex Yang, San Francisco, CA (US); Sri Radhakrishnan, Cupertino, CA (US); Steve Wallace, Tracy, CA (US); Surag Mantri, Sunnyvale, CA (US); Greg Pulido, Sunnyvale, CA (US); Ramon Estrada, San Lorenzo, CA (US)

(72) Inventors: Hoang Nguyen, San Jose, CA (US); Ryan Olivera, Granite Bay, CA (US); Alex Yang, San Francisco, CA (US); Sri Radhakrishnan, Cupertino, CA (US); Steve Wallace, Tracy, CA (US); Surag Mantri, Sunnyvale, CA (US); Greg Pulido, Sunnyvale, CA (US); Ramon Estrada, San Lorenzo, CA (US)

(73) Assignee: Pulmonx Corporation, Redwood City, CA (US)

(21) Appl. No.: 13/748,346

(22) Filed: Jan. 23, 2013

Related U.S. Application Data
(60) Provisional application No. 61/590,127, filed on Jan. 24, 2012.

(51) Int. Cl. G09B 23/32

(52) U.S. Cl. CPC G09B 23/32
USPC 434/272

(57) ABSTRACT

A system for simulating a breathing lung is disclosed. The system comprises a lung model contained within an enclosure, wherein a main bronchus of the lung model is open to ambient air. In one embodiment, the system also comprises a vacuum pump connected to the enclosure, a first normally closed 2-way valve connected to the enclosure, a flow controller connected to both the vacuum pump and the enclosure, and a timer connected to the first normally closed 2-way valve. In alternative embodiments, the system comprises a first pump connected to the enclosure and a second pump connected to the enclosure, wherein the first and second pumps work independently of each other, and wherein the first pump is a vacuum pump, and the second pump is either a peristaltic pump or a piston pump.

### CROSS-REFERENCE TO RELATED APPLICATIONS

This application claims the benefit of U.S. Provisional Application No. 61/590,127 (Attorney Docket No. 20920-765.101), filed Jan. 24, 2012, the entire content of which is incorporated herein by reference.

### FIELD OF THE INVENTION

This invention relates generally to devices and systems for simulating the function bodily organs, and specifically to devices and systems for simulating lung function.

### DESCRIPTION OF THE RELATED ART

The use of simulated bodily organs such as the lungs has existed for various purposes, particularly in the fields of medical training and/or medical equipment demonstration. Perhaps the most well known is the use of CPR mannequins (for example as disclosed in U.S. Pat. No. 3,276,147 to de Bella, U.S. Pat. No. 4,001,950 to Blumensaadt, and U.S. Pat. No. 3,049,811 to Ruben), that typically use inflatable plastic bags contained within movable chest cavities.

In the pulmonology field, there has been a particular need for a device or system simulating the normal physiological function of the lungs, particularly the normal breathing pattern of the lungs. Several devices exist that are made of synthetic materials, such as plastic, that attempt to recreate a breathing model of a lung. See, for example, U.S. Pat. No. 5,403,192 to Kleinwaks et al., U.S. Pat. No. 6,874,501 to Estetter et al., RE29,317 to Mosley et al., and U.S. Pat. No. 7,021,940 to Morris et al.

Such plastic models, however, have several limitations for use as training or demonstration models. They are often inaccurate or insufficiently replicate the complex passageways found within a human lung. Further, the tactile feel of the plastic model while training with or demonstrating medical equipment does not sufficiently replicate the feel of an animal organ.

The use of an alternative animal lung, (e.g. a pig lung) has been suggested as an alternative. Typically, the lung, after extraction from the deceased animal, is preserved in a preservation fluid such as formaldehyde and a tube is affixed to the bronchus. Suction and/or inflation are provided by inserting a device into the trachea and suctioning and/or introducing air into the lung via the trachea to simulate breathing. This model is limited in that since the main bronchus is used for the simulated breathing, the lung cannot be accessed via the main bronchus for any experiments or demonstration. Further, this model has several limitations, the biggest being an inability to adjust various breathing characteristics such as respiration cycle time, flow rate and pressure mechanics of breathing. It is the object of the present invention to address at least some of these shortcomings.

### SUMMARY OF THE INVENTION

A system for simulating a breathing lung is disclosed. The system comprises a lung model contained within an enclosure, wherein a main bronchus of the lung model is open to ambient air. The system also comprises a vacuum pump connected to the enclosure, a first normally closed 2-way valve connected to the enclosure, a flow controller connected to both the vacuum pump and the enclosure, and a timer connected to the first normally closed 2-way valve.

The system may further comprise a second normally closed 2-way valve connected to the vacuum pump, and a silencer configured to reduce the exhaust noise emanating from the pump. The vacuum pump is configured to remove air from the enclosure. The first normally closed 2-way valve is configured to permit air removed from the enclosure by the vacuum pump to be reintroduced into the enclosure. The timer controls at least one operation of the first normally closed 2-way valve, wherein the operation may comprise controlling a frequency of opening of the first normally closed 2-way valve. The frequency of opening of the first normally closed 2-way valve translates to a frequency of simulated breathing of the lung model.

Also described is a system for simulating a breathing lung, the system comprising a lung model contained within an enclosure, wherein a main bronchus of the lung is open to ambient air. The system also comprises a first pump connected to the enclosure and a second pump connected to the enclosure, wherein the first and second pumps work independently of each other. In some embodiments, the first pump is a vacuum pump and the system may further comprise a vacuum pump and a vacuum regulator attached to the vacuum pump, and/or a silencer attached to the vacuum pump. The vacuum pump is configured to remove air from the enclosure, wherein removal of air from the enclosure results in a simulated exhalation of the lung model. The second pump of the system is configured to introduce air into the enclosure, resulting in a simulated inhalation of the lung model. In some embodiments, the second pump is a peristaltic pump, and in some embodiments, the second pump is a piston pump.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 shows a main embodiment of the present invention

FIG. 2 shows an alternative embodiment of the present invention.

FIG. 3 shows another alternative embodiment of the present invention.

### DETAILED DESCRIPTION OF THE INVENTION

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

The present invention comprises systems, devices and methods of manufacture of an enhanced breathing lung simulator. Specifically, the present embodiments disclose systems, devices and methods for simulating breathing in a preserved lung enclosed in an enclosure. In the first embodiment, breathing simulation is accomplished via the use of, inter alia, a vacuum pump affixed to a flow controller, which is in turn affixed to a 2-way valve. The 2-way valve is affixed to a timer.

In operation, the vacuum pump and the solenoid valve work in concert to simulate inhalation and exhalation of the lung. The flow controller controls the flow of the air to the lung enclosure. A timer is affixed to the solenoid valve to assist in timing the duration of the breathing cycle. Optionally, a silencer and a second valve are provided in order to muffle the sounds of air being released from the pump, and to vent the lung enclosure prior to commencement of the inhalation/exhalation cycle.

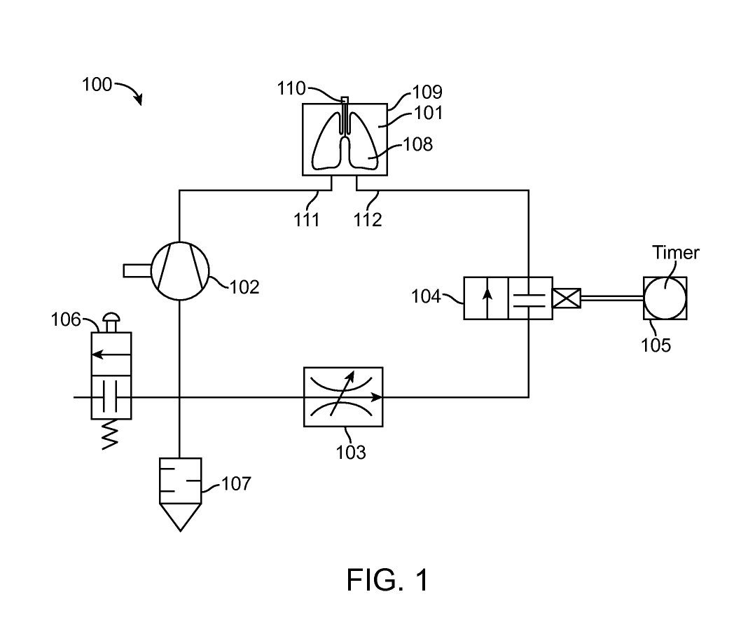

Turning to the figures, FIG. 1 illustrates an embodiment of the present invention. The system 100 comprises a lung enclosure 101, a vacuum pump 102, a flow controller 103, a normally closed 2-way solenoid valve 104 and a relay timer 105. System 100 optionally comprises a normally closed 2-way push button valve 106 and a silencer 107.

The lung enclosure 101 comprises a lung model 108 that is affixed within the enclosure through any method. As shown here, the lung model (lung) is affixed on a stand that at least partially suspends the lung within the center of the enclosure 101. Optionally, the enclosure comprises a separator (not shown), exemplarily in the shape of a triangle or pyramid, to separate the two main lobes of the lung. The lung is exemplarily an extracted animal lung, such as a pig lung, that has been preserved in a preserving fluid, such as formaldehyde. However, any artificial lung capable of expanding and collapsing may be used. The lung 108 is enclosed within walls 109 such that the main body of the lung 108 is contained within the enclosure, while the main bronchus 110 protrudes from an opening on the enclosure. The main bronchus is thus accessible for simulations or demonstrations using various medical equipment such as bronchoscopes or catheters. Further, the enclosure is configured such that it has one or more connections (111, 112), to connect to other components of the system, for example the vacuum pump and the normally closed solenoid valve. It should be noted that the enclosure 101 is airtight to the extent that even the opening to accommodate the main bronchus 110, and the openings for the connections 111, 112, are thoroughly sealed so as to maintain the airtight integrity of the enclosure 101.

The vacuum pump 102 is connected to the enclosure 101 via connection 111. Vacuum pump 102 is configured to create a vacuum within lung enclosure 101, by extracting air from the lung enclosure via connection 111. Accordingly, the connection 111 in this instance is a tube or hose or similar object that is configured to transport air or fluids. When the vacuum pump is in operation, air is pulled by the pump 102 from the lung enclosure 101 via connection 111. The result of removing air from the enclosure is the creation of a vacuum or negative pressure within the enclosure, outside the lung. Simultaneously, the protrusion of the main bronchus 110 from the opening in the enclosure results in the inside of the lung having pressure that is equal to the pressure of ambient air. Thus, when the vacuum is applied, the result is that there is a negative pressure surrounding the outside of the lung relative to the inside of the lung. This causes the lung to expand, simulating an inhalation. As will be seen below, if air is thereafter introduced into the enclosure 101, the result is a decrease of the negative pressure created by the vacuum, or a creation of positive pressure around the lung 108. This causes the lung to collapse, or lose its expansion, thereby simulating an exhalation.

Vacuum pump 102 is connected via one or more connections to the flow controller 103. Flow controller 103 controls the flow of air between the vacuum pump and the lung enclosure. In FIG. 1, flow controller 103 is shown as not being directly attached to the lung enclosure 101, though it is within the scope of the invention that flow controller 103 may be placed in direct connection to the lung enclosure 101. The flow controller 103 controls air flow via a dial (not shown), or other similar mechanism. Additionally, the flow controller 103 may be made from any suitable material, for example plastic or stainless steel. The flow controller, as shown in FIG. 1, is connected to the lung enclosure via a solenoid valve 104, for example, a normally-closed 2-way solenoid valve. The solenoid valve is configured to allow exhaust air from the vacuum pump to be periodically, and under user control (as described below), be introduced into the lung enclosure via connection 112. When such introduction of air occurs, it essentially reverses the effects of the ‘inhalation’ caused by the vacuum pump as described above and instead causes a simulated exhalation. It should be noted that though a solenoid valve is used in this purpose, any valve capable of the above functions can be used.

In this embodiment, the valve 104 is connected to a timer 105. The timer 105, exemplarily a relay timer, controls the time to energize the valve 104, thereby controlling the frequency and duration of the opening and closing of the solenoid valve 104. The configuration between timer 105 and valve 104 is such that a user can set a desired valve opening and/or valve closing interval to ultimately control the rate of either or both inhalation and exhalation of the lung.

The vacuum pump 102 is also optionally configured to permit exhaustion of all air from the enclosure 101 prior to commencement of the desired inhalation and exhalation cycle of the enclosed lung 108. The benefit of exhausting all the air is that once all air is exhausted from the enclosure 101, the lung 108 will inflate faster upon commencement of the inhalation/exhalation cycle. Typically, exhausting will occur simultaneously with the commencement of vacuuming the air from the pig lung. This means that the lung will be also be inflated from either a normal or deflated state during the exhaustion process. It should be noted, however, that not all the air being exhausted need be cycled back into the enclosure. A user may use the flow controller 103 to adjust the amount of air returning to the lung enclosure. In the current embodiment, a normally-closed 2-way push button valve is envisioned, though it should be noted that any valve capable of the above functions may be used.

The vacuum pump is also optionally configured to be connected to a silencer 107 (for example a pneumatic silencer). The silencer 107 is configured to reduce noises emanating from the vacuum pump 102 during the latter's operation.

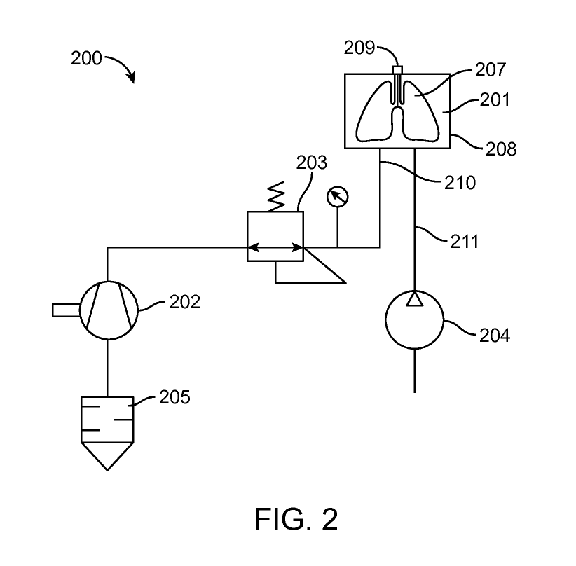

FIG. 2 illustrates an alternative embodiment of the present invention. In this embodiment, a vacuum pump and a peristaltic pump independently, but in concert, work to simulate inhalation and exhalation respectively. The system 200 comprises a lung enclosure 201, a vacuum pump 202, a vacuum regulator 203, a peristaltic pump 204 and optionally, a silencer 205.

The lung enclosure 201 is substantially similar to the lung enclosure 101 described above. Specifically, the lung enclosure 201 comprises a lung model 207 that is affixed within the enclosure through any method. As shown here, the lung model (lung) 207 is affixed on a stand that suspends the lung within the center of the enclosure 201. The lung is exemplarily an extracted animal lung, such as a pig lung, that has been preserved in a preserving fluid, such as formaldehyde. However, any artificial lung capable of expanding and collapsing may be used. The lung 207 is enclosed within walls 208 such that the main body of the lung is contained within the enclosure, while the main bronchus 209 protrudes from an opening on the enclosure. The main bronchus is thus accessible for simulations or demonstrations using various medical equipment such as bronchoscopes or catheters. Further, the enclosure is configured such that it has one or more connections (210, 211), to connect to other components of the system, for example the vacuum pump and the normally closed solenoid valve. It should be noted that the enclosure is airtight to the extent that even the opening for the main bronchus 209 and the openings for the connections 210, and 211 are thoroughly sealed so as to maintain the airtight integrity of the enclosure 201.

The vacuum pump 202 is connected to the enclosure 101 via connection 210. Vacuum pump 202 is configured to create a vacuum within lung enclosure 201, by extracting air from the lung enclosure via connection 210. Accordingly, the connection 210 in this instance is a tube or hose or similar object that is configured to transport air or fluids. When the vacuum pump is in operation, a fixed volume of air is pulled by the pump 202 from the lung enclosure 201 via connection 210. The result of removing air from the enclosure is the creation of a vacuum or negative pressure within the enclosure, outside the lung. Simultaneously, the protrusion of the main bronchus 209 from the opening in the enclosure results in the inside of the lung having pressure that is equal to the pressure of ambient air. Thus, when the vacuum is applied, the result is that there is a negative pressure surrounding the outside of the lung relative to the inside of the lung. This causes the lung to expand, simulating an inhalation. As will be seen below, if air is thereafter introduced into the enclosure 201, the result is a decrease of the negative pressure created by the vacuum or a creation of positive pressure around the lung 207. This causes the lung to lose its expansion or collapse, thereby simulating an exhalation.

In this embodiment, the vacuum pump is configured such that it is connected to a vacuum regulator 203 that regulates the vacuum that is created within enclosure 201. Vacuum regulator 203 is placed along the connection 210 between the vacuum pump 202 and the enclosure 201. Optionally, the vacuum regulator comprises a vacuum gauge 206 that measures the vaccum pressure created by the regulator 203.

In this embodiment, the lung enclosure 201 is also attached to a separate peristaltic pump 204 via connection 211. The peristaltic pump 204 is configured to act independently but in concert with the vacuum pump 202 to direct air into the lung enclosure 201. As discussed above, such an introduction of air serves to reverse the effects of the simulated inhalation created by the vacuum pump. The peristaltic pump 204 thus directs a fixed volume of air into the lung enclosure 201 to create a simulated exhalation. The peristaltic pump 204 is configured such that the frequency of the pump and the volume of the air being pumped are controllable via a user to control both the rate and degree, respectively, of the simulated exhalation.

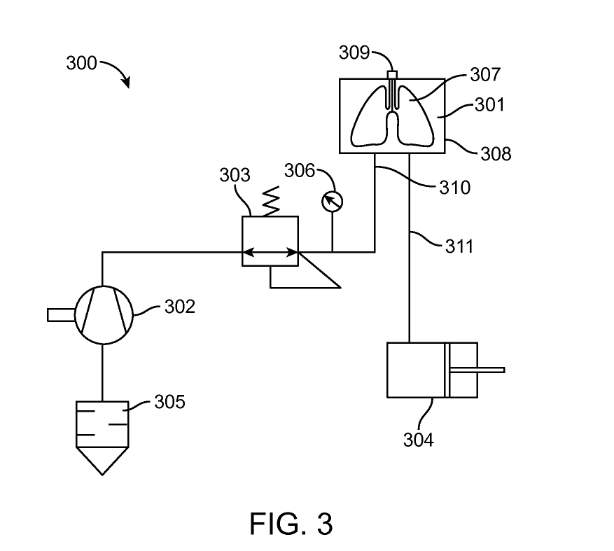

Alternatively, as shown in FIG. 3, a piston pump may be used in lieu of a peristaltic pump shown in FIG. 3. System 300 is similar to system 200, with the exception that a piston pump is substituted for a peristaltic pump. The lung enclosure 301, similar to enclosures 201 and 101, comprises a lung model 307 enclosed within walls 308, such that the main bronchus 309 protrudes from an opening in the enclosure. Enclosure 301 is connected to a vacuum pump 302 via connection 310, with a vacuum regulator 303, and optionally a vacuum gauge 306, located therebetween. An optional silencer 305 is connected to the pump. As in the previous embodiment, the vacuum pump 302 creates a vacuum inside the lung enclosure 301 to inflate the lung to simulate lung inhalation. The vacuum regulator 303 regulates the vacuum inside the enclosure 301. The piston pump 304, which is connected to the enclosure 301 via connection 311, alternatively pumps air into the lung enclosure (for example when the piston creates pressure within a cylinder of the piston pump), and draws air from the lung enclosure (for example when the piston creates a vacuum within a cylinder of the piston pump). The cycle and volume of the piston pump controls the cycle and pressure of the lung inhalation and exhalation cycles.

While the above is a complete description of the preferred embodiments of the invention, various alternatives, modifications, and equivalents may be used. Therefore, the above description should not be taken as limiting the scope of the invention which is defined by the appended claims.

What is claimed is:

1. A system for simulating a breathing lung, the system comprising:
a lung model contained within an enclosure, wherein a main bronchus of the lung model is open to ambient air;
a vacuum pump connected to the enclosure;
a first normally closed 2-way valve connected to the enclosure;
a flow controller connected to both the vacuum pump and the enclosure; and
a timer connected to the first normally closed 2-way valve.

2. the system of claim 1, further comprising a second normally closed 2-way valve connected to the vacuum pump.

3. The system of claim 1, further comprising a silencer configured to reduce the exhaust noise emanating from the pump.

4. The system of claim 1, wherein the vacuum pump is configured to remove air from the enclosure.

5. The system of claim 1, wherein the first normally closed 2-way valve is configured to permit air removed from the enclosure by the vacuum pump to be reintroduced into the enclosure.

6. The system of claim 1, wherein the timer controls at least one operation of the first normally closed 2-way valve.

7. The system of claim 6, wherein the operation comprises controlling a frequency of opening of the first normally closed 2-way valve.

8. The system of claim 7, wherein the frequency of opening of the first normally closed 2-way valve translates to a frequency of simulated breathing of the lung model.

9. A system for simulating a breathing lung, the system comprising:
a lung model contained within an enclosure, wherein a main bronchus of the lung model is open to ambient air;
a first pump connected to the enclosure; and
a second pump connected to the enclosure, wherein the first and second pumps work independently of each other.

10. The system of claim 9, wherein the first pump is a vacuum pump.

11. The system of claim 10, further comprising a vacuum regulator attached to the vacuum pump.

12. The system of claim 10, further comprising a silencer attached to the vacuum pump.

13. The system of claim 10, wherein the vacuum pump is configured to remove air from the enclosure.

14. The system of claim 13, wherein removal of air from the enclosure results in a simulated exhalation of the lung model.

15. The system of claim 9, wherein the second pump is configured to introduce air into the enclosure.

16. The system of claim 15, wherein the introduction of air from the enclosure results in a simulated inhalation of the lung model.

17. The system of claim 9, wherein the second pump is a peristaltic pump.

18. The system of claim 9, wherein the second pump is a piston pump.
